(19) United States
(12) Patent Application Publication
(10) Pub. No.: US 2003/0066063 A1
(43) Pub. Date: Apr. 3, 2003

(54) Information processing apparatus, information processing method, information processing system, and storage medium

(76) Inventor: Yasuhiro Yokota, Kanagawa (JP)

Correspondence Address: ROSSI & ASSOCIATES, P.O. Box 826, Ashburn, VA, 20146-0826, US

(21) Appl. No.: 09/859,969

(22) Filed: May 17, 2001

(30) Foreign Application Priority Data
May 22, 2000 (JP) 2000-150416

(51) Int. Cl. G06F 9/44

(52) U.S. Cl. 717/173

(57) ABSTRACT

There is provided an information processing apparatus which enables reliable installation of a program in a target apparatus when execution of the program is instructed by an apparatus other than the target apparatus even if the program is not installed in the target apparatus, without turning to the other apparatus which instructed execution of the program. An information processing apparatus is connected to a server via a network and connected to at least one external device, for executing a program designated by the at least one external device. A program download section of the apparatus is operable when the designated program is not installed in the apparatus, for downloading the designated program from the server on the network.

### BACKGROUND OF THE INVENTION

1. Field of the Invention

This invention relates to a technique of loading of a program in a target apparatus, such as a personal computer (hereinafter referred to as a “PC”) or an embedded system, and execution of the program by the target apparatus, when execution of the program is instructed from another PC or a mobile device to the target apparatus.

2. Related Background Art

Conventionally, a PC or a mobile device executes a program by reading the program from an external storage device, such as a hard disk, and storing the read program in a main storage device thereof.

With the recent advent of the Internet age, it is now a common practice to use an information browsing program called a browser, which is running on a PC or a mobile device to download a program from another PC on a network, such as a server, for execution of the program. More specifically, even when a program is not installed in a PC or a mobile device which is in use by the user, the browser can download the program for execution only by designating information indicative of the location of the program in another PC on a network, such as a server.

According to the art, however, although it is thus possible to download a program to a PC or a mobile device in use by the user and execute the downloaded program, a target apparatus cannot execute a program which it has been instructed to execute unless the program is installed in the target apparatus.

A simple and apparent solution to this problem is to send the program from the user's PC or mobile device to the target apparatus to cause the same to execute the program.

However, this solution is merely superficial and impractical, because it is necessary to store a program to be executed by the target apparatus in an external storage device of the user's PC or mobile device beforehand, which leads to wasteful use of a storage area of the external storage device of the target apparatus. Further, the user must know in advance the architecture or operating system (OS) of the target apparatus to determine what program should be sent to the target apparatus.

Moreover, especially for a mobile device which is limited in resources of a memory and the like, it is impossible even to store programs to be executed by the target apparatus. Further, even if a program or programs to be executed by the target apparatus can be stored in the mobile device, it is not practical from the viewpoint of data transfer rate to use infrared rays or a phone line via a cellular phone as communication means for sending the program(s) to a target apparatus.

### SUMMARY OF THE INVENTION

It is an object of the present invention to provide an information processing apparatus, an information processing method, and an information processing system, which enable reliable installation of a program in a target apparatus when execution of the program is instructed by an apparatus other than the target apparatus even if the program is not installed in the target apparatus, without turning to the other apparatus which instructed execution of the program, and a storage medium storing a program for executing the method.

To attain the above object, according to a first aspect of the invention, there is provided an information processing apparatus that is connected to a server via a network, for executing a program designated by a user.

The information processing apparatus according to the first aspect of the invention is characterized by comprising receiving means for receiving a designation of the program to be executed from the user, download means operable when the designated program is not installed in the information processing apparatus, for downloading the designated program from the server on the network.

Preferably, the information processing apparatus includes authentication means for authenticating the user who logs on to the information processing apparatus via at least one external device, first storage means for storing information indicative of a history of at least one program, execution of which was instructed in the past by the authenticated user, on an authenticated user-by-authenticated user basis, second storage means for storing the designated program, and prior-read means operable upon authentication of the user by the authentication means, for referring to the information of the history stored in the first storage means and reading the at least one program, execution of which was instructed in the past by the authenticated user, into the second storage means, before the designated program is executed.

More preferably, the information processing apparatus includes third storage means for storing the at least one program, execution of which was instructed in the past, and the prior-read means reads any of the at least one program, execution of which was instructed in the past, into the second storage means from the third storage means when the any of the at least one program, execution of which was instructed in the past, is stored in the third storage means, and from the server on the network when the any of the at least one program, execution of which was instructed in the past, is not stored in the third storage means, before the designated program is executed.

Further preferably, the download means downloads the designated program from the server on the network when the designated program is not stored in the third storage means.

Further preferably, the information processing apparatus includes storage control means for storing at least one program which has been downloaded by the download means a predetermined number of times, in the third storage means.

Still more preferably, the predetermined number of times is set to an arbitrary number of times depending on each program downloaded by the download means.

Still more preferably, the information processing apparatus includes deletion means for deleting any of the at least one program stored in the third storage means by the storage control means, from the third storage means when the any of the at least one stored program has not been executed for a predetermined time period.

Still further preferably, the predetermined time period is set to an arbitrary time period depending on each program downloaded by the download means.

To attain the above object, according to a second aspect of the invention, there is provided an information processing method of executing a program designated by a user, comprising the steps of receiving a designation of the program to be executed from the user, downloading the designated program from a server on a network when the designated program is not installed in an information processing apparatus connected to the server via the network and connected to at least one external device, and causing the information processing apparatus to execute the program designated by the user.

To attain the above object, according to a third object of the invention, there is provided an information processing system comprising at least one external device, a server, an information processing apparatus connected to the server via a network and connected to the at least one external device, download means for downloading a program designated by the at least one external device from the server on the network when the designated program is not installed in the information processing apparatus, and execution means for executing the program designated by the at least one external device.

To attain the above object, according to a fourth object of the invention, there is provided a computer-readable storage medium storing a program for executing the information processing method according to the second aspect of the invention.

The above and other objects, features, and advantages of the invention will become more apparent from the following detailed description taken in conjunction with the accompanying drawings.

### BRIEF DESCRIPTION OF THE DRAWINGS

FIG. 1 is a diagram schematically showing the arrangement of an information processing system to which the present invention is applied;

FIG. 2 is a block diagram schematically showing various sections representative of data-processing functions of a target apparatus (information processing apparatus);

FIG. 3 is a diagram illustrating an example of a storage location management table;

FIG. 4 is a diagram illustrating an example of an execution history management table;

FIG. 5 is a flowchart showing a program for carrying out an overall control process according to a first embodiment of the present invention;

FIG. 6 is a flowchart showing for a subroutine for carrying out a program-loading process appearing in FIG. 5;

FIG. 7 is a diagram illustrating an example of a storage/deletion management table;

FIG. 8 is a flowchart showing a program for carrying out an overall control process according to a second embodiment of the present invention;

FIG. 9 is a flowchart showing a subroutine for carrying out a program storage/deletion process appearing in FIG. 8; and

FIG. 10 is a diagram showing a memory map of a storage medium for storing program code groups of CPU-readable control programs.

### DETAILED DESCRIPTION OF PREFERRED EMBODIMENTS

The present invention will now be described in detail with reference to the drawings showing embodiments thereof.

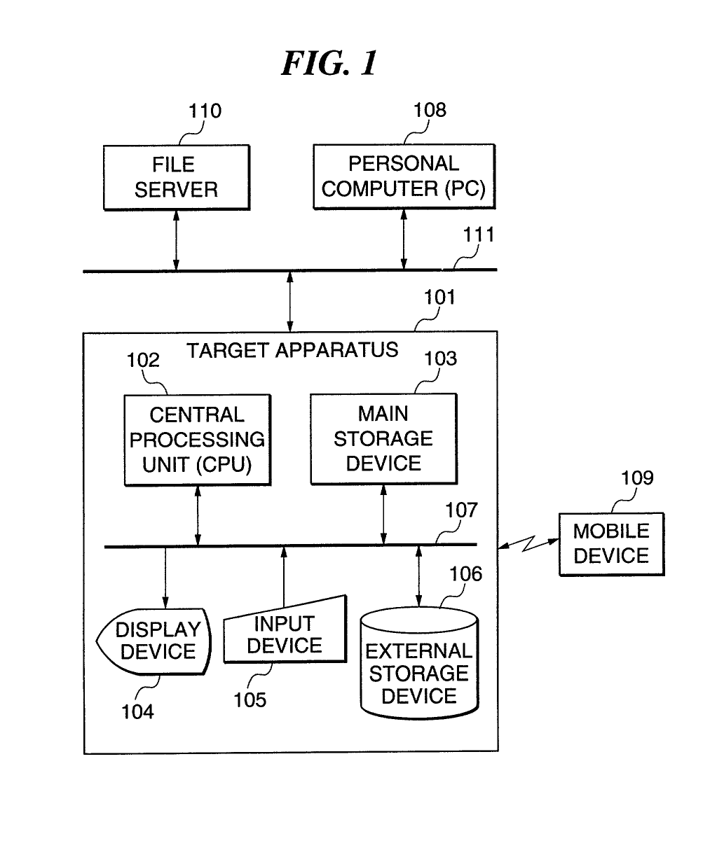

Now, a first embodiment of the present invention will be described with reference to FIGS. 1 to 6.

Referring first to FIG. 1, there is schematically shown the arrangement of an information processing system to which the present invention is applied.

In the figure, reference numeral 101 designates a target apparatus (information processing apparatus), such as a personal computer (PC), a work station (WS), or an embedded system. Reference numeral 102 designates a central processing unit (CPU) formed by a microprocessor or the like for carrying out processing operations, referred to hereinafter. Reference numeral 103 designates a main storage device (second storage means) formed by a RAM or the like. This main storage device 103 stores an operating system (OS) and programs read from an external storage device 106 (third storage means), for execution thereof.

Reference numeral 104 designates a display device formed e.g. by a CRT display or a liquid crystal display, for displaying the running state of a program being executed. Reference numeral 105 designates an input device, such as a keyboard and a pointing device.

The external storage device 106 incorporated in the target apparatus 101 includes a storage medium, such as a hard disk, a magneto-optical disk, a PC card memory, or a flash memory, and stores the operating system (OS) and application programs. Reference numeral 107 designates a bus for sending and receiving data and signals between the above component parts of the target apparatus 101.

Reference numeral 108 designates a personal computer (PC) (external device) which is used, in the present embodiment, for instructing the target apparatus 101 to execute a program or programs. Reference numeral 109 designates a mobile device (external device), such as a small-sized mobile terminal unit, a PDA (Personal Digital Assistant), or a cellular phone, which is connected to the target apparatus 101 for instructing execution of a program or programs.

Reference numeral 110 designates a file server that stores programs and is connected to the target apparatus 101 via a network 111. The network 111 connects the target apparatus 101 and the file server 110 on the network 111 to each other, for allowing data to be sent and received therebetween.

With the system arrangement described above, when the target apparatus 101 is requested by the PC 108 or the mobile device 109 to execute a program, the central processing unit 102 reads the program requested for execution, from the external storage device 106 of the target apparatus 101, or downloads the program from the file server 110 on the network 111, into the main storage device 103, for execution.

The running state of the program being executed is displayed on the display device 104, and data required for execution of the program are input via the input device 105.

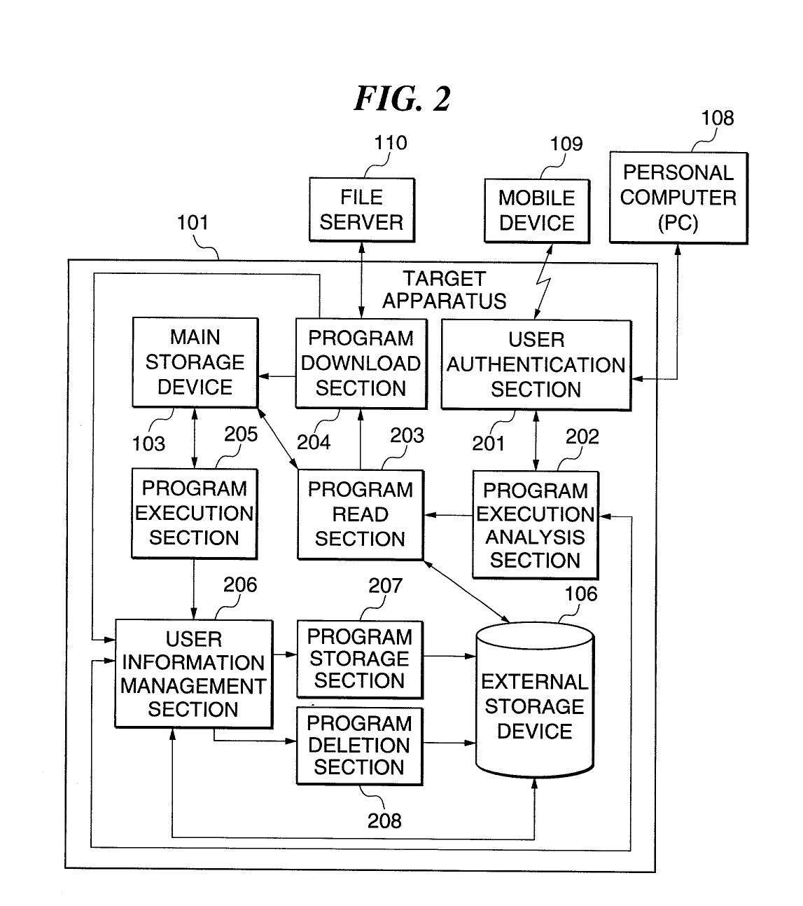

FIG. 2 is a block diagram schematically showing sections representative of data-processing functions of the target apparatus 101. In the figure, reference numeral 201 indicates a user authentication section (authentication means) which controls a user's log-on to the target apparatus 101 via the PC 108 or the mobile device 109 and at the same time identifies the user who logs on, that is, authorizes the user.

Reference numeral 202 indicates a program execution analysis section which monitors a request for execution of a program from the authorized user. If a program is requested for execution, the program execution analysis section 202 instructs a program read section 203 (prior-read means) to read the program, and immediately after authorizing the user, analyzes execution history information indicative of programs which were executed in the past in response to requests from the authorized user. This information, referred to hereinafter, is stored in a user information management section 206 (first storage means). If the analysis teaches that there are any programs to be read in advance into the main storage device 103, the program execution analysis section 202 instructs the program read section 203 to read these programs into the main storage device 103.

The program read section 203 reads programs from the external storage device 106 of the target apparatus 101, and stores the read programs in the main storage device 103. At this time, if a program is not stored in the external storage device 106, the program read section 203 instructs a program download section 204 (download means) to download the program from the file server 110 on the network 111.

The program download section 204 downloads the program from the file server 110 on the network 111, and stores the same in the main storage device 103.

Reference numeral 205 designates a program execution section which executes a program or programs stored in the main storage device 103. At this time, the program execution section 205 instructs the user information management section 206 to store execution history information indicative of programs executed by authorized users, on a user-by-user basis. The user information management section 206 stores the execution history information.

It should be noted that a program storage section 207 (storage control means) and a program deletion section 208 (deletion means) are associated with a second embodiment of the present invention, referred to hereinafter.

In the first embodiment configured as above, the user authentication section 201 controls a user's log-on to the target apparatus 101 from the PC 108 or the mobile device 109, the program execution analysis section 202 analyzes a request for execution of a program made by the user, and the program read section 203 reads out the requested program from the external storage device 106 to store the same in the main storage device 103. In this process, if the requested program is not stored in the external storage device 106, the program download section 204 downloads the program from the file server 110 on the network 111 to store the same in the main storage device 103.

The program execution section 205 executes the program stored in the main storage device 103 and at the same time instructs the user information management section 206 to store the execution history information for the user logged on. Further, immediately after the user logs on, the program execution analysis section 202 analyzes the execution history information indicative of the programs executed in the past, which was stored by the user information management section 206. If there are any program or programs to be read into the main storage device 103 beforehand, the program execution analysis section 202 instructs the program read section 203 to read the program(s) into the main storage device 103.

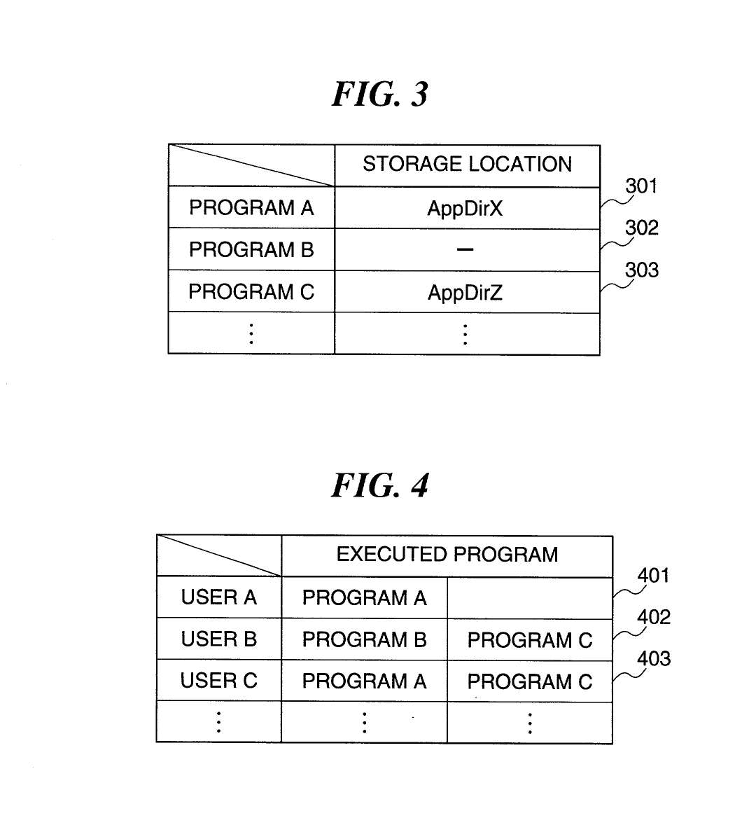

FIG. 3 illustrates an example of a storage location management table. The storage location management table records storage location information indicative of which directories of the external storage device 106 of the target apparatus 101 store programs to be executed by the target apparatus 101 or do not store one or more of the programs.

For instance, in FIG. 3, a row designated by reference numeral 301 shows that a program A is stored in a directory AppDirX. A row designated by reference numeral 302 shows that a program B is not stored in the external storage device 106 of the target apparatus 101. A row designated by reference numeral 303 shows that a program C is stored in a directory AppDirZ.

FIG. 4 illustrates an example of an execution history management table which records the execution history information indicative of programs executed in the past by each user who logged on to the target apparatus 101.

For instance, in FIG. 4, a row designated by reference numeral 401 shows that a user A executed only the program A. A row designated by reference numeral 402 shows that a user B executed the program B and the program C. A row designated by reference numeral 403 shows that a user C has executed the program A and the program C.

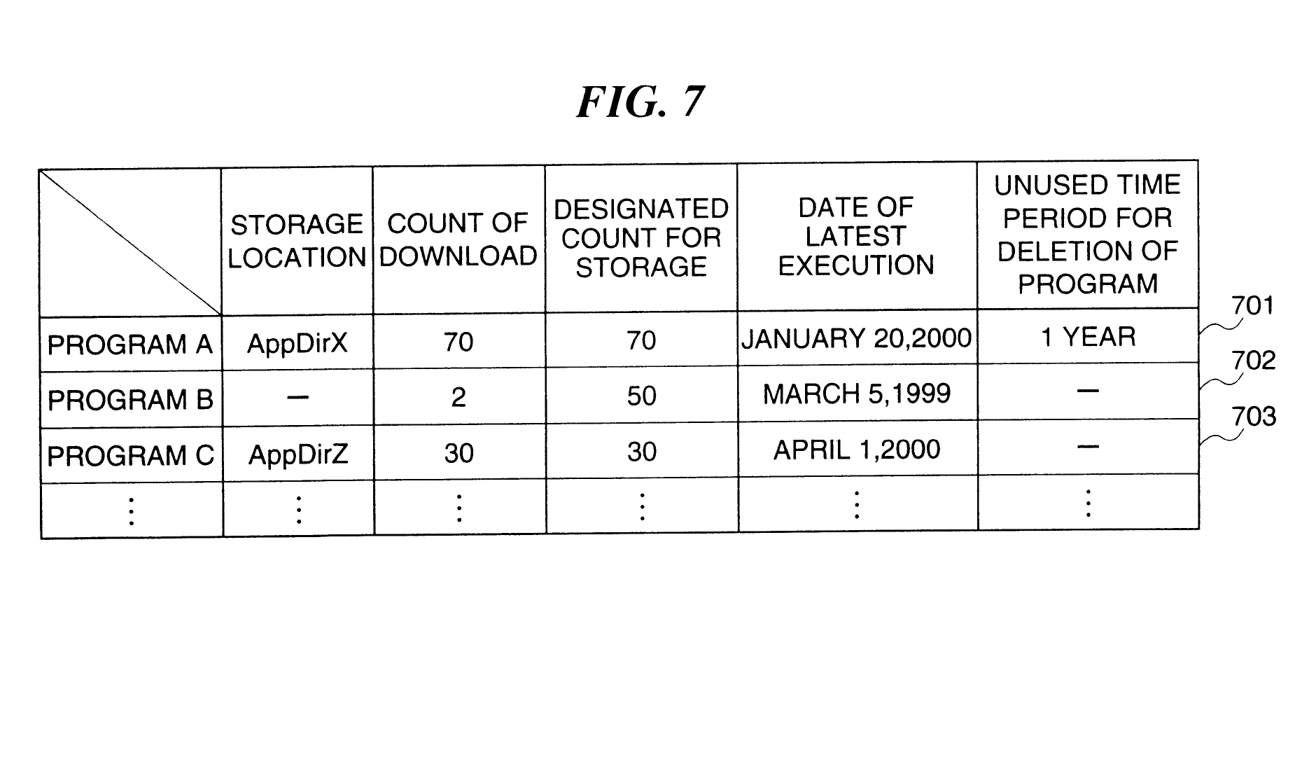

It should be noted that access to the FIG. 3 storage location management table, the FIG. 4 execution history management table, and a storage/deletion management table, referred to hereinafter, shown in FIG. 7 is carried out by the user information management section 206.

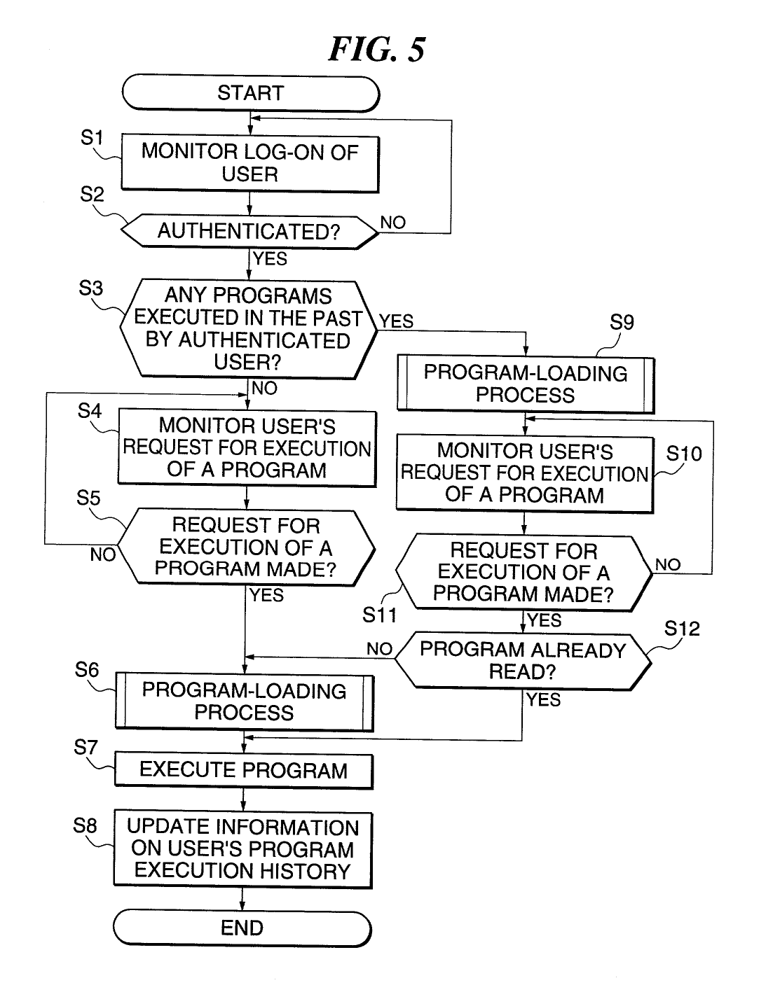

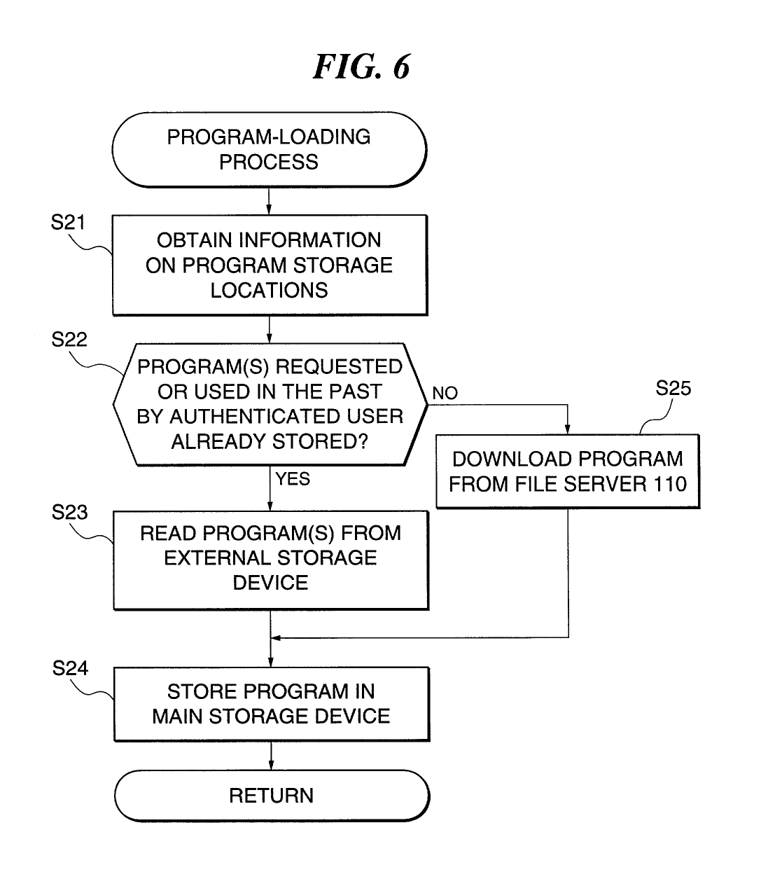

FIGS. 5 and 6 are flowcharts showing a program for carrying out a control process by the target apparatus 101 according to the first embodiment.

Program codes representative of this control process are stored in the main storage device 103, while the central processing unit 102 executes the program code, thereby realizing the functions of the user authentication section 201, the program execution analysis section 202, the program read section 203, the program download section 204, the program execution section 205, and the user information management section 206.

More specifically, these program codes correspond to a control process of the target apparatus 101 carried out in response to a request for execution of a program made by a user operating an external device, such as the PC 108 or the mobile device 109, such that the program is read from the external storage device 106 or downloaded from the file server 110 on the network 111, and executed, and information on the executed program is recorded in the execution history management table.

Now, the above control process will be described in detail hereinafter. Referring first to FIG. 5, log-on of users to the target apparatus 101 is monitored at a step S1. When a user is authorized to log on at a step S2, then, at a step S3, it is determined based on the execution history management table whether or not any programs were executed in the past by the authorized user.

If no program was executed by the user in the past, the user's request for execution of a program is monitored at a step S4. If a request for execution of a program is made (step S5), the requested program is loaded at a step S6 and executed at a step S7, while updating information on the user's program execution history at a step S8.

If the look-up of the execution history management table at the step S3 teaches that a program or programs were executed in the past by the authorized user, the program or all the programs are loaded at a step S9 so as to complete reading of the program(s) prior to a user's request for execution of any of them.

Then, at a step S10, a request for execution of a program from the user is monitored. If the execution of a program is requested by the user at a step S11, it is determined at a step S12 whether or not the program has already been read. When the program has already been read, the present program proceeds to the step S7, wherein the requested program is executed.

If it is determined at the step S12 that the program requested for execution has not yet been read, the program is loaded at the step S6.

FIG. 6 is a flowchart showing a subroutine for a program-loading process which is executed at the step S6 or S9 in FIG. 5.

Referring to FIG. 6, information on program storage locations is obtained from the storage location management table at a step S21, and it is determined at a step S22 whether or not the program(s) used by the authorized user in the past, or the program requested by the user for execution are/is stored in the external storage device 106 of the target apparatus 101. If stored, the program(s) are/is read out from the external storage device 106 at a step S23, and stored in the main storage device 103 at a step S24, followed by the process returning to the FIG. 5 main routine.

On the other hand, if it is determined at the step S22 that the program(s) are/is not stored in the external storage device 106 of the target apparatus 101, the program is downloaded from the file server 110 on the network 111 at a step S25, and stored in the main storage device 103 at the step S24, followed by the process returning to the FIG. 5 main routine.

As described hereinabove, according to the first embodiment, when the target apparatus 101 is requested to execute a program, by a user using the PC 108 or the mobile device 109, even if the program is not installed in the target apparatus 101, it is possible to automatically download the program from the external file server 110 for execution. Therefore, the user need not worry about whether or not the program is installed in the target apparatus 101 any longer.

Further, it becomes unnecessary for an administrator of the target apparatus 101 not only to install programs to be requested by users in each of a large number of apparatuses in the office or like location but also to worry about the capacity of the external storage device 106 since programs can be downloaded via the network 111 for execution even when the target apparatus 101 does not include the external storage device 106 or when the same includes the external storage device 106 which, however, does not have a sufficient capacity for storing the programs.

Furthermore, according to the present embodiment, information on the titles or the like of executed programs is stored on a user-by-user basis, and programs of which the titles or the like are stored are read into the main storage device 103 beforehand immediately after a user is authorized to log on to the target apparatus. This makes it possible to shorten a time period from a time a request for execution of a program is made by the user to a time the program starts to be executed.

Although in the first embodiment, programs downloaded via the network 111 are only stored in the main storage device 103 for execution, in a second embodiment of the present invention, a count (number of times) of downloading of each program is recorded, and when the same program is downloaded a designated number of times (predetermined number of times), the program is automatically stored in the external storage device 106 of the target apparatus 101. Further, the date of each execution of a program is recorded on a program-by-program basis, and if there exists a program which has not been executed by any user for a designated time period (predetermined time period), the program is automatically deleted from the external storage device 106.

In the following, the second embodiment will be described in detail with reference to FIGS. 2, 7, 8 and 9.

Referring first to the block diagram of FIG. 2 already referred to hereinabove for describing the first embodiment, only components directly related to the second embodiment will be described.

As shown in the figure, the program download section 204 downloads a program from the file server 110 on the network 111 to store the program in the main storage device 103. When downloading the program, the program download section 204 instructs the user information management section 206 to update the count of downloading of the program.

The program execution section 205 executes a program stored in the main storage device 103. When executing the program, the program execution section 205 instructs the user information management section 206 to record the date of execution of the program.

The user information management section 206 records the count of downloading of each program from the file server 110 on the network 111. When the same program is downloaded a designated number of times, the user information management section 206 instructs the program storage section 207 to automatically store the program in the external storage device 106 of the target apparatus 101.

Further, the user information management section 206 records the date of execution of each program, and if a program has not been executed by any user for the designated time period, the user information management section 206 instructs the program deletion section 208 to automatically delete the program from the external storage device 106 of the target apparatus 101.

The program storage section 207 stores programs in the external storage device 106. The program deletion section 208 deletes programs from the external storage device 106.

According to the configuration of the second embodiment shown in the above block diagram, the program download section 204 downloads a program from the file server 110 on the network 111 to store the program in the main storage device 103 while the user information management section 206 updates the count of downloading of the program. If the same program is downloaded a designated number of times, the program storage section 207 automatically stores the program in the external storage device 106 of the target apparatus 101.

Further, the program execution section 205 executes programs stored in the main storage device 103. The user information management section 206 records the date of execution of each program. If a program has not been executed by any user for the designated time period, the program deletion section 208 automatically deletes the program from the external storage device 106 of the target apparatus 101.

FIG. 7 is a diagram illustrating the storage/deletion management table used in the second embodiment.

The storage/deletion management table records information necessary for execution of storage and deletion of programs. This information includes directories of the external storage device 106 of the target apparatus 101 in which programs to be executed are stored, the count of downloading of each program carried out in the past, a value set to a designated number of times of downloading required to be carried out before each program associated therewith is automatically stored in the external storage device 106, the date of the latest execution of each program, a value set to a time period required to elapse without each program being executed by any user before the program is automatically deleted from the external storage device 106.

More specifically, as shown in FIG. 7, a row designated by reference numeral 701 stores information concerning the program A, that is, the program is stored in a directory AppDirX, was downloaded 70 times in the past, and is to be automatically stored in the external storage device 106 of the target apparatus 101 when it is downloaded a designated number (arbitrary value) of times. The illustrated example shows that the program has been downloaded 70 times, and hence is stored in the directory AppDirX. Further, the information also includes the date of Jan. 20, 2000, which is the date of the latest execution of the program A, and one year (arbitrary time period) set to a time period required to elapse without being executed by any user before it is deleted from the external storage device 106.

A row designated by reference numeral 702 stores information on the program B, that is, the program B is not stored in the external storage device 106 of the target apparatus 101), was downloaded twice, and is to be automatically stored in the external storage device 106 when it is downloaded 50 (arbitrary value) times. The illustrated example shows that the program has been downloaded only twice and hence is not stored in the external storage device 106. Further, it is also shown that although the program was last executed on Mar. 5, 1999, a time period (arbitrary time period) required to elapse without being used before deleting the program has not been set since the program has not been stored in the external storage device 106 yet.

A row designated by reference numeral 703 stores information on the program C, that is, the program C is stored in a directory AppDirZ, was downloaded 30 times in the past, and is to be automatically stored in the external storage device 106 of the target apparatus 101 when it is downloaded 30 (arbitrary value) times. The illustrated example shows that the program has been downloaded 30 times and hence is stored in the directory AppDirZ. Further, it is also shown that although the program was last executed on Apr. 1, 2000, a time period (arbitrary time period) required to elapse before deleting the same is not set since this program is desired to be always stored in the external storage device 106.

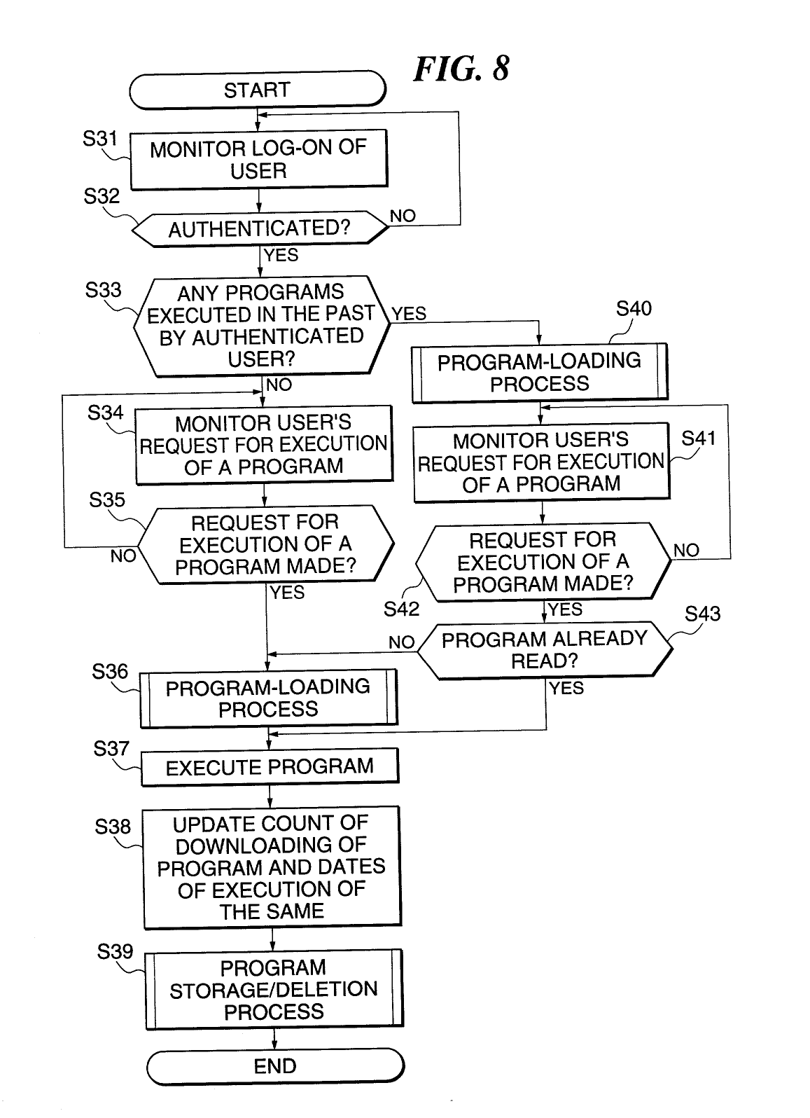

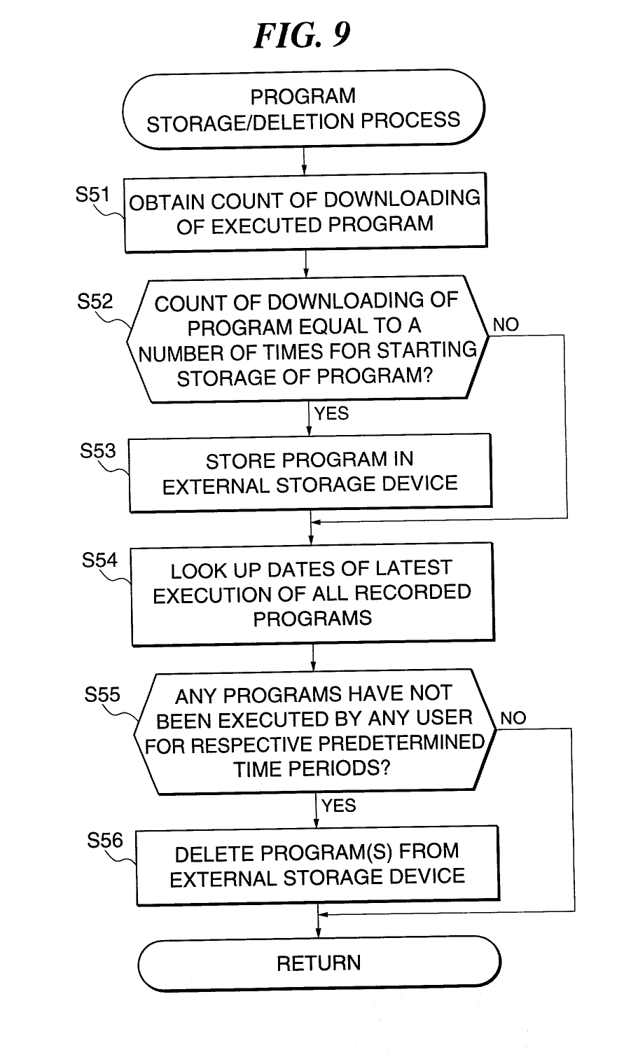

FIGS. 8 and 9 are flowcharts showing a program for carrying out a control process by the target apparatus 101 according to the second embodiment.

Program codes representative of this control process correspond to a control process carried out by the target apparatus 101 in response to a request for execution of a program made by a user operating an external device, such as the PC 108 or the mobile device 109, such that the program requested for execution is executed by reading the same from the external storage device 106 of the target apparatus or downloading the same from the file server 110 on the network 111, and after recording information on the executed program in the execution history management table, the program is automatically stored in the external storage device 106 or automatically deleted therefrom depending on the number of times of downloading the program and the date of the latest execution of the program.

In the present embodiment, as shown in FIG. 8, log-on of users to the target apparatus 101 is monitored at a step S31, and when a user is authorized to log on at a step S32, it is determined at a step S33 based on the execution history management table whether or not any programs were executed in the past by the authorized user.

If no program was executed by the user in the past, a request for execution of a program by the user is monitored at a step S34. If a request for execution of a program is made at a step S35, the requested program is loaded at a step S36 and executed at a step S37.

If the executed program is a downloaded one, the count of downloading of the program and the dates of execution of the program are updated at a step S38, followed by carrying out a program storage/deletion process at a step S39.

If the look-up of the execution history management table at the step S33 teaches that there is/are a program or programs executed in the past by the authorized user, the program or all the programs are loaded at a step S40 to complete reading of the programs prior to a user's request for execution of any of the programs.

Then, at a step S41, a request for execution of a program by the user is monitored. If a request for execution of a program is made by the user at a step S42, it is determined at a step S43 whether or not the program has already been read. When the program has already been read, the present program proceeds to the step S37, wherein the requested program is executed.

If it is determined at the step S43 that the program requested for execution has not yet been read, the program is loaded at the step S36.

FIG. 9 is a flowchart showing a subroutine for the program storage/deletion process carried out at the step S39 in FIG. 8.

Referring to FIG. 9, the count of downloading of the executed program is obtained from the FIG. 7 storage/deletion table at a step S51, and then it is determined at a step S52 whether or not the count of downloading of the program is equal to a number of times (predetermined number of times) for starting storage of the program (storage starting number) set for the program. If the count of downloading of the program has become equal to the storage starting number, the program is stored in the external storage device 106 of the target apparatus 101 at a step S53.

Next, the dates of the latest execution of all the recorded programs are looked up from the FIG. 7 storage/deletion management table at a step S54, and it is determined at a step S55 whether or not there are any programs which have not been executed by any user for respective predetermined time periods, which are set on a program-by-program basis. If there is/are any, the program(s) is/are deleted from the external storage device 106, and information stored in the entry box(es) of storage locations of corresponding rows of the storage/deletion table is deleted at a step S56, followed by the process returning to the FIG. 8 main routine.

At the step S52, if the count of downloading of the executed program has not yet reached the storage starting number set for the program, the dates of the latest execution of all the recorded programs are obtained at the step S54.

At the step S55, if there is no program which has not been executed by any user for the time period (predetermined time period) designated for the program, the present program returns to the FIG. 8 main routine.

As described hereinabove, according to the second embodiment, the count of downloading of each downloaded program is recorded, and if the count of downloading becomes equal to a storage starting number set for the program, the program is automatically stored in the external storage device 106 of the target apparatus 101. Therefore, there is no need to download, from the file server 110 on the network 111, programs which are frequently executed, whenever such programs are executed, and at the same time it is possible to shorten a time period before the program starts to be executed in response to a user's request for execution thereof. Further, since only programs that are frequently executed are stored in the external storage device 106, it is possible to make efficient use of the external storage device 106 without wastefully using the same.

Furthermore, according to the present embodiment, the dates of execution of programs are recorded, and a program which has not been executed by any user for a time period set for the program is automatically deleted from the external storage device 106. Therefore, it is possible to prevent the external storage device 106 from continuing to wastefully store programs whose frequency of execution is reduced. This also contributes to efficient use of the external storage device 106.

Further, the administrator of the target apparatus 101 is no longer required to uninstall a program which has ceased to be used by any user, from a large number of computers (PC's) in his office, computer by computer.

Although in the above described embodiments, the program code groups shown in FIGS. 5, 6, 8 and 9 are loaded from the external storage device 106 into the main storage device 103, and are read from the main storage device 103 for execution, this is not limitative, but a storage medium in the external storage device 106 or an internal storage medium may be caused to store the above program code groups such that the central processing unit 102 can directly read out the program codes from the storage medium for execution thereof.

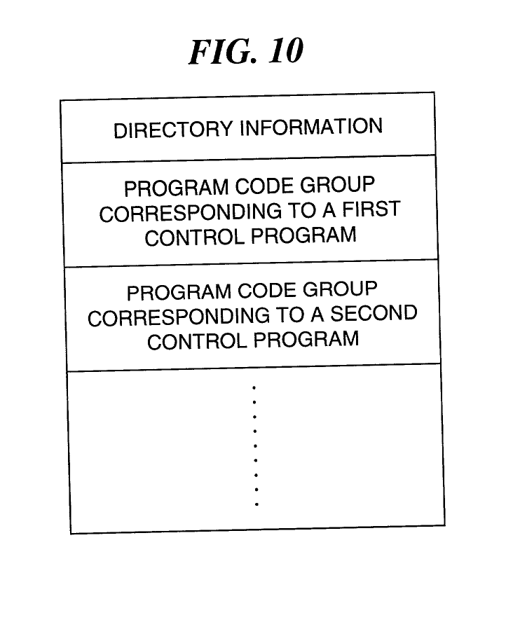

FIG. 10 shows a memory map (directory information) of a storage medium that stores program code groups of control programs readable by the central processing unit 102.

This storage medium stores the program codes represented by the flowcharts shown in FIGS. 5 and 6, that is, program codes according to the first embodiment as a program code group corresponding to a first control program. Further, the storage medium stores the program codes represented by the flowcharts shown in FIGS. 8 and 9, that is, program codes according to the second embodiment as a program code group corresponding to a second control program.

Although not shown, the above storage medium may store information for managing stored program groups, such as information on versions of the programs and information on a creator of each program, as well as information dependent on the OS and other conditions of a computer on the readout side, e.g. icons that are displayed to identify the respective programs.

Further, data subordinate to the programs are also managed by the above-mentioned directory information. Further, the above storage medium may store programs for installing various kinds of programs in a computer or a program for expanding programs which are in compressed form.

Further, the functions of the program code groups shown in FIG. 10 may be realized through execution of programs installed from an external device by the information processing system according to the present invention. In this case, an information group including the programs may be supplied to the present system by means of a storage medium, such as a CD-ROM, a flash memory, or a FD, or from an external storage medium via the network.

In this way, the present invention can be realized by supplying a storage medium storing a software program implementing the functions of the present embodiment to a system or apparatus, and causing a computer (CPU or MPU) of the system or apparatus to read out and execute the program stored in the storage medium.

In this case, the program codes themselves which are read out from the storage medium achieve the novel functions of the present invention, and the storage medium storing the program constitutes the present invention.

The storage medium for supplying the program to the system or apparatus may be a floppy disk, a hard disk, an optical disk, an magneto-optical disk, a DVD, a CD-ROM, a CD-R (CD-Recordable), a magnetic tape, a nonvolatile memory card, a ROM, or an EEPROM (electrically erasable programmable read-only memory), for instance.

The present invention encompasses a case in which the functions of the illustrated embodiments are accomplished not only by executing the program codes read out by the computer, but also by causing an operating system (OS) operating on the computer to perform a part or all of actual operations according to instructions of the program codes.

Still further, the present invention also encompasses a case in which the program codes read out from the storage medium are written into a memory included in an expanded function board inserted into the computer or in an expanded function unit connected to the computer, and then the CPU or the like incorporated in the expanded function board or the expanded function unit actually performs a part or all of the operations, based on the instructions of the program codes, so as to accomplish the functions of the illustrated embodiments.

The present invention may be applied to a system constituted by a plurality of units of apparatuses or an apparatus formed by a single unit thereof. Further, the advantageous effects of the invention can be enjoyed by causing the system or apparatus to download and read out a program represented by software for accomplishing the object of the invention, from a database on a network, according to a communication program.

As described hereinbefore, according to the present invention, an information processing apparatus for executing a program, execution of which is instructed by an external device, includes download means for downloading the program from a server on a network if the instructed program is not installed in the information processing apparatus. As a result, even if a program, execution of which is instructed by another apparatus, is not installed in a target apparatus, it is possible to reliably install the program in the target apparatus without turning to the other apparatus which instructed execution of the program.

What is claimed is:

1. An information processing apparatus that is connected to a server via a network, for executing a program designated by a user, the information processing apparatus comprising:
receiving means for receiving a designation of the program to be executed from the user;
download means operable when the designated program is not installed in the information processing apparatus, for downloading the designated program from the server on the network.

2. An information processing apparatus according to claim 1, including:
authentication means for authenticating the user who logs on to the information processing apparatus via at least one external device;
first storage means for storing information indicative of a history of at least one program, execution of which was instructed in the past by the authenticated user, on an authenticated user-by-authenticated user basis;
second storage means for storing the designated program; and
prior-read means operable upon authentication of the user by said authentication means, for referring to the information of the history stored in said first storage means and reading the at least one program, execution of which was instructed in the past by the authenticated user, into said second storage means, before the designated program is executed.

3. An information processing apparatus according to claim 2, including third storage means for storing the at least one program, execution of which was instructed in the past, and
wherein said prior-read means reads any of the at least one program, execution of which was instructed in the past, into said second storage means from said third storage means when the any of the at least one program, execution of which was instructed in the past, is stored in said third storage means, and from the server on the network when the any of the at least one program, execution of which was instructed in the past, is not stored in said third storage means, before the designated program is executed.

4. An information processing apparatus according to claim 3, wherein said download means downloads the designated program from the server on the network when the designated program is not stored in said third storage means.

5. An information processing apparatus according to claim 3 or 4, including storage control means for storing at least one program which has been downloaded by said download means a predetermined number of times, in said third storage means.

6. An information processing apparatus according to claim 5, wherein said predetermined number of times is set to an arbitrary number of times depending on each program downloaded by said download means.

7. An information processing apparatus according to claim 5, including deletion means for deleting any of the at least one program stored in said third storage means by said storage control means, from said third storage means when the any of the at least one stored program has not been executed for a predetermined time period.

8. An information processing apparatus according to claim 7, wherein said predetermined time period is set to an arbitrary time period depending on each program downloaded by said download means.

9. An information processing method of executing a program designated by a user, comprising the steps of:
receiving a designation of the program to be executed from the user;
downloading the designated program from a server on a network when the designated program is not installed in an information processing apparatus connected to the server via the network and connected to at least one external device; and
causing the information processing apparatus to execute the program designated by the user.

10. An information processing system comprising:
at least one external device;
a server;
an information processing apparatus connected to said server via a network and connected to said at least one external device;
download means for downloading a program designated by said at least one external device from said server on the network when the designated program is not installed in said information processing apparatus; and
execution means for executing the program designated by said at least one external device.

11. A computer-readable storage medium storing a program for executing an information processing method of executing a program designated by a user, the program comprising:
a rceiving module for receiving a designation of the program to be executed from the user;
a download module for downloading the designated program from a server on a network when the designated program is not installed in an information processing apparatus connected to the server via the network; and
an execution module for causing the information processing apparatus to execute the program designated by the user.
